(19) United States
(12) Patent Application Publication
(10) Pub. No.: US 2026/0297253 A1
(43) Pub. Date: Oct. 1, 2026

(54) SULFONATED POLY(PHENYLENE ETHER) AND METHOD FOR THE MANUFACTURE THEREOF

(71) Applicant: SHPP Global Technologies B.V., Bergen op Zoom (NL)

(72) Inventors: Neha Lamba, Bangalore (IN); Girish Chandra, Bangalore (IN); Anshita Sudarshan, Bangalore (IN); Rajesh Chowdhury, Bangalore (IN); Omkar Gadgil, Bangalore (IN); Gopee Kottakota, Bangalore (IN); Surya Prakasa Rao Daliparthi, Bangalore (IN); Debasish Banerjee

(21) Appl. No.: 19/478,735

(22) PCT Filed: Apr. 12, 2024
(86) PCT No.: PCT/IB2024/053631

§ 371 Date: Oct. 24, 2025

(30) Foreign Application Priority Data
Apr. 28, 2023 (EP) 23170792.8

(51) Int. Cl. C08G 65/38

(52) U.S. Cl. CPC C08G 65/38

(57) ABSTRACT

A sulfonated poly(phenylene ether) is described herein. The sulfonated poly(phenylene ether) has a degree of sulfonation of 15 to 50%. At least 90% of the sulfonated poly(phenylene ether) repeating units of the sulfonated poly(phenylene ether) are monosubstituted. Methods for the manufacture of the sulfonated poly(phenylene ether) and articles prepared therefrom are also disclosed.

### CROSS REFERENCE TO RELATED APPLICATION

This application claims priority to and the benefit of European Patent Application No. 23170792.8, filed on Apr. 28, 2023, the contents of which are hereby incorporated by reference in their entirety.

### BACKGROUND

Disclosed herein is a sulfonated poly(phenylene ether) and methods for making the sulfonated poly(phenylene ether).

Poly(phenylene ether) s are commercially attractive materials because of their unique combination of physical, chemical, and electrical properties. Furthermore, the combination of poly(phenylene ether) s with other polymers or additives provides blends which result in improved overall properties including chemical resistance, high strength, and high flow. As new commercial applications are explored, various sulfonated grades of poly(phenylene ether) materials are desired.

Conventional methods for sulfonating poly(phenylene ether) develop heterogeneity with progressive levels of sulfonation, affecting the reaction system making further sulfonation impossible.

Accordingly, there remains a continuing need in the art for an improved sulfonating process which can provide high sulfonation levels (e.g., up to 50%), and can further provide a high percentage of monosubstituted repeating units. It would be further advantageous to provide sulfonated poly(phenylene ethers) having reduced levels of residual components, e.g., residual solvent.

### SUMMARY

An aspect of the disclosure is a sulfonated poly(phenylene ether) comprising repeating units of the formula

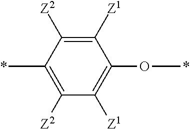

wherein in the foregoing formula, Z¹ is independently at each occurrence a sulfonic acid group, a sulfonyl chloride group, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; Z² is independently at each occurrence a sulfonic acid group, a sulfonyl chloride group, hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and wherein the sulfonated poly(phenylene ether) has a degree of sulfonation of 15 to 50% as determined by nuclear magnetic resonance spectroscopy; and wherein at least 90% of the sulfonated poly(phenylene ether) repeating units of the sulfonated poly(phenylene ether) are monosubstituted.

Another aspect of the disclosure is a membrane comprising the sulfonated poly(phenylene ether).

Another aspect of the disclosure is a method of making a sulfonated poly(phenylene ether), the method comprising: contacting a poly(phenylene ether) with a sulfonating agent in the presence of a solvent comprising 1,2-dichloroethane and a cosolvent comprising ethyl acetate under conditions effective to provide a mixture comprising the sulfonated poly(phenylene ether); and isolating the sulfonated poly(phenylene ether) from the mixture; wherein the poly(phenylene ether) is present in an amount of greater than or equal to 8 weight percent, based on the total weight of the poly(phenylene ether), the sulfonating agent, the solvent, and the cosolvent, preferably wherein the poly(phenylene ether) is present in an amount of 8 to 25 weight percent; the cosolvent is present in an amount of 7 to 15 weight percent based on the total weight of the solvent and the cosolvent; and wherein the sulfonating agent is present in a weight ratio of sulfonating agent to poly(phenylene ether) of less than 0.5:1, preferably 0.1:1 to 0.45:1.

The above described and other features are exemplified by the following figure and detailed description.

### BRIEF DESCRIPTION OF THE DRAWINGS

The following figure represents an exemplary embodiment.

FIG. 1 shows a chemical structure of an exemplary sulfonated poly(phenylene ether) according to an aspect of the present disclosure.

### DETAILED DESCRIPTION

The present inventors have unexpectedly discovered that a sulfonated poly(phenylene ether) having a high degree of sulfonation can be provided by selecting particular method conditions for preparing the sulfonated poly(phenylene ether). In a further advantageous feature, the sulfonated poly(phenylene ether) can have a high degree of monosubstitution (i.e., of the repeating units that are sulfonated, at least 90% have only one sulfonate group). With the ability to efficiently produce poly(phenylene ether) with sulfonation levels of 15 to 50%, various diverse products are possible. For example, ion exchange membranes for dialysis, proton conducting membranes for polymer electrolyte membrane fuel cells, ion exchange membranes for flow batteries, hollow fiber membranes, precursor for molecular sieve carbon membranes for gas separation, precursor for carbon electrodes for fuel cells, carbon membrane reactors, etc. A significant improvement is therefore provided by the present disclosure.

Accordingly, an aspect of the present disclosure is a method of making a sulfonated poly(phenylene ether). The degree of sulfonation can be controlled by adjusting an amount of solvent and cosolvent in the process, by adjusting the amount of sulfonating agent used, and adjusting the concentration of the poly(phenylene ether) in the reaction mixture.

The process according to the present disclosure comprises contacting a poly(phenylene ether) with a sulfonating agent in the presence of a solvent and a cosolvent to sulfonate the poly(phenylene ether). The solvent comprises 1,2-dichloroethane. The cosolvent comprises at least one of methyl ethyl ketone, diethyl ether, methyl ethyl sulfone, ethyl acetate (EA), or tetramethylene sulfone. In an aspect, the cosolvent comprises at least one of ethyl acetate, or tetramethylene sulfone. In a specific aspect, the cosolvent comprises ethyl acetate.

Poly(phenylene ether) s include those comprising repeating structural units having the formula

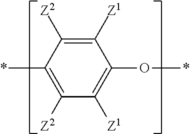

wherein each occurrence of Z¹ independently comprises halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and each occurrence of Z² independently comprises hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In an aspect, the poly(phenylene ether) comprises 2,6-dimethyl-1,4-phenylene ether units, 2,3,6-trimethyl-1,4-phenylene ether units, or a combination thereof. In an aspect, the poly(phenylene ether) is a poly(2,6-dimethyl-1,4-phenylene ether). In an aspect, the poly(phenylene ether) comprises a poly(2,6-dimethyl-1,4-phenylene ether) having an intrinsic viscosity of 0.03 to 2 deciliter per gram (dl/g). For example, the poly(phenylene ether) can have an intrinsic viscosity of 0.25 to 1.7 dl/g, specifically 0.25 to 0.7 dl/g, more specifically 0.35 to 0.55 dl/g, even more specifically 0.35 to 0.50 dl/g, measured at 25° C. in chloroform using an Ubbelohde viscometer.

In an aspect, the poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, a block copolymer, or an oligomer as well as combinations thereof.

Poly(phenylene ether) as used herein can also refer to lower molecular weight phenylene ether oligomers. In an aspect, the phenylene ether oligomer comprises 2,6-dimethyl-1,4-phenylene ether units, 2,3,6-trimethyl-1,4-phenylene ether units, or a combination thereof. In an aspect, the phenylene ether oligomer can have an intrinsic viscosity of 0.03 to 0.13 dl/g, or 0.05 to 0.1 dl/g, or 0.1 to 0.15 dl/g, measured at 25° C. in chloroform using an Ubbelohde viscometer. The phenylene ether oligomer can have a number average molecular weight of 500 to 7,000 grams per mole (g/mol), and a weight average molecular weight of 500 to 15,000 g/mol, as determined by gel permeation chromatography using polystyrene standards. In an aspect, the number average molecular weight can be 750 to 4,000 g/mol, and the weight average molecular weight can be 1,500 to 9,000 g/mol, as determined by gel permeation chromatography using polystyrene standards.

The phenylene ether oligomer can be monofunctional or bifunctional. In an aspect, the phenylene ether oligomer can be monofunctional. For example, it can have a functional group at one terminus of the polymer chains. The functional group can be, for example, a hydroxyl group or a (meth)acrylate group, preferably a (meth)acrylate group. In an aspect, the phenylene ether oligomer comprises poly(2,6-dimethyl-1,4-phenylene ether).

In an aspect, the phenylene ether oligomer can be bifunctional. For example, it can have functional groups at both termini of the oligomer chain. The functional groups can be, for example, hydroxyl groups or (meth)acrylate groups, preferably (meth)acrylate groups. Bifunctional polymers with functional groups at both termini of the polymer chains are also referred to as “telechelic” polymers. In an aspect, the phenylene ether oligomer comprises a bifunctional phenylene ether oligomer having the structure

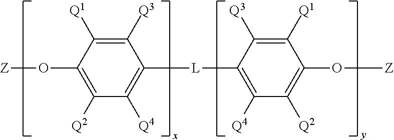

wherein Q¹ and Q² each independently comprise halogen, unsubstituted or substituted C₁₋₁₂ primary or secondary hydrocarbyl, C₁₋₁₂ hydrocarbylthio, C₁₋₁₂ hydrocarbyloxy, and C₂₋₁₂ halohydrocarbyloxy wherein at least two carbon atoms separate the halogen and oxygen atoms; each occurrence of Q³ and Q⁴ independently comprise hydrogen, halogen, unsubstituted or substituted C₁₋₁₂ primary or secondary hydrocarbyl, C₁₋₁₂ hydrocarbylthio, C₁₋₁₂ hydrocarbyloxy, and C₂₋₁₂ halohydrocarbyloxy wherein at least two carbon atoms separate the halogen and oxygen atoms; Z is hydrogen or (meth)acrylate; x and y are independently 0 to 30, or 0 to 20, or 0 to 15, or 0 to 10, or 0 to 8, provided that the sum of x and y is at least 2, or at least 3, or at least 4; and L has the structure

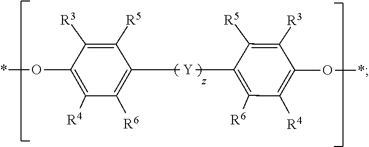

wherein each occurrence of R³ and R⁴ and R⁵ and R⁶ independently comprises hydrogen, halogen, unsubstituted or substituted C₁₋₁₂ primary or secondary hydrocarbyl, C₁₋₁₂ hydrocarbylthio, C₁₋₁₂ hydrocarbyloxy, and C₂₋₁₂ halohydrocarbyloxy wherein at least two carbon atoms separate the halogen and oxygen atoms; z is 0 or 1; and Y has a structure comprising

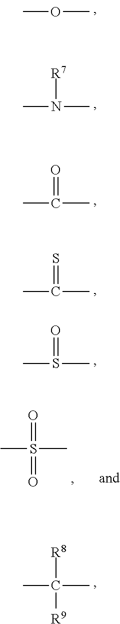

wherein each occurrence of R⁷ independently comprises hydrogen and C₁₋₁₂ hydrocarbyl, and each occurrence of R⁸ and R⁹ independently comprises hydrogen, C₁₋₁₂ hydrocarbyl, and C₁₋₆ hydrocarbylene wherein R⁸ and R⁹ collectively form a C₄₋₁₂ alkylene group.

In an aspect, the phenylene ether oligomer comprises a bifunctional phenylene ether oligomer having the structure

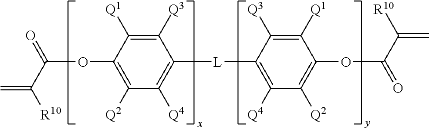

wherein Q¹, Q², Q³, Q⁴, L, x and y are as defined above R¹⁰ is methyl or hydrogen

In the (meth)acrylate-terminated phenylene ether structure above, there are limitations on the variables x and y, which correspond to the number of phenylene ether repeating units at two different places in the bifunctional phenylene ether oligomer. In the structure, x and y are independently 0 to 30, or 0 to 20, or 0 to 15, or 0 to 10, or 0 to 8. The sum of x and y is at least 2, or at least 3, or at least 4. A phenylene ether oligomer can be analyzed by proton nuclear magnetic resonance spectroscopy (1H NMR) to determine whether these limitations are met, on average. Specifically, 1H NMR can distinguish between protons associated with internal and terminal phenylene ether groups, with internal and terminal residues of a polyhydric phenol, and with terminal residues as well. It is therefore possible to determine the average number of phenylene ether repeating units per molecule, and the relative abundance of internal and terminal residues derived from dihydric phenol.

In an aspect the phenylene ether oligomer comprises a bifunctional phenylene ether oligomer having the structure

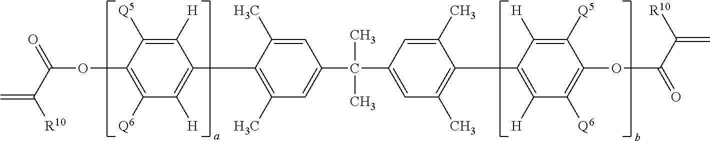

wherein each occurrence of Q⁵ and Q⁶ independently comprises methyl, di-n-butylaminomethyl, or morpholinomethyl; and each occurrence of a and b is independently 0 to 20, with the proviso that the sum of a and b is at least 2; and each occurrence of R¹⁰ is methyl or hydrogen. An exemplary bifunctional phenylene ether oligomer includes NORYL™ Resin SA9000, available from SABIC.

In an aspect the phenylene ether oligomer comprises a bifunctional phenylene ether oligomer having the structure

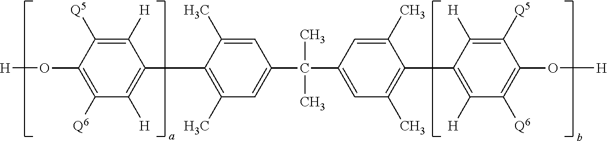

wherein each occurrence of Q⁵ and Q⁶ independently comprises methyl, di-n-butylaminomethyl, or morpholinomethyl; and each occurrence of a and b is independently 0 to 20, with the proviso that the sum of a and b is at least 2. An exemplary bifunctional phenylene ether oligomer includes NORYL™ Resin SA90, available from SABIC.

In an aspect, the poly(phenylene ether) comprises a poly(phenylene ether) homopolymer, oligomer, or combination thereof. The poly(phenylene ether) can preferably comprise a poly(2,6-dimethyl-1,4-phenylene ether).

The process for the sulfonation of the poly(phenylene ether) comprises contacting the poly(phenylene ether) with a sulfonating agent in the presence of a solvent and a cosolvent. In an aspect, the method comprises dissolving the poly(phenylene ether) in the solvent and the cosolvent to form a poly(phenylene ether) mixture. Mixing of the components of the mixture can be performed at temperatures of 10 to 60° C., e.g., 25 to 40° C. The solvent comprises 1,2-dichloroethane and is present in a sufficient quantity to dissolve the poly(phenylene ether). The amount of cosolvent is sufficient to prevent precipitation of the sulfonated poly(phenylene ether) before the desired degree of sulfonation has been attained.

The solvent mixture can comprise greater than or equal to 8 weight percent of the poly(phenylene ether), or greater than 10 weight percent of poly(phenylene ether), or greater than 12 weight percent of the poly(phenylene ether). Within this range, the solvent mixture can comprise 8 to 25 weight percent, preferably 8 to 20 weight percent, or 10 to 25 weight percent, or greater than 10 to 25 weight percent, or 10 to 20 weight percent, or 15 to 25 weight percent, or 15 to 20 weight percent of the poly(phenylene ether), each based on the total weight of the poly(phenylene ether), the sulfonating agent, the solvent, and the cosolvent.

The solvent (i.e., the 1,2-dichloroethane) can be present in the reaction in an amount of 60 to 99 weight percent, or 70 to 95 weight percent, or 70 to 85 weight percent, each based on the total weight of the poly(phenylene ether), the sulfonating agent, the solvent, and the cosolvent.

The cosolvent can be present in the reaction in an amount of 7 to 15 weight percent based on the total weight of the solvent and the cosolvent. For example, the cosolvent can be present in an amount of 8 to 12 weight percent. In an aspect, the cosolvent can be present in an amount of at least 10 weight percent, for example 10 to 15 weight percent, or greater than 10 to 15 weight percent, or 11 to 15 weight percent, or 12 to 15 weight percent, each based on the total weight of the solvent and the cosolvent.

The poly(phenylene ether) is reacted with a sulfonating agent to sulfonate the poly(phenylene ether). The sulfonation can be performed at a temperature of up to 85° C., e.g., 10 to 60° C., or 25 to 40° C. The amount of sulfonating agent added to the reaction mixture can be selected to provide a weight ratio of sulfonating agent to poly(phenylene ether) of less than 0.5:1. For example, a weight ratio of sulfonating agent to poly(phenylene ether) can be 0.1:1 to 0.45:1, or 0.2:1 to 0.4:1. In an aspect, the sulfonating agent can be added slowly to the reaction mixture, e.g., added over a period of 15 minutes (min.) to 60 min., (e.g., over a period of 30 mins.). Once the sulfonating agent is added to the solvent mixture, the solvent mixture can be stirred, e.g., for a period of time of 60 to 210 mins., prior to proceeding to isolation of the sulfonated product.

The method further comprises isolating the sulfonated poly(phenylene ether) from the mixture. For example, once the poly(phenylene ether) has been sulfonated, the sulfonated poly(phenylene ether) can be precipitated from the solvent mixture using an anti-solvent mixture, e.g., containing de-ionized (DI) water and an organic solvent. As the organic solvent, hexane, heptane, cyclopentane, or cycloheptane can be used (along with de-ionized water) to cause the sulfonated poly(phenylene ether) to precipitate out of the reaction solvent mixture. The present inventors have advantageously found that particular organic solvents can be especially useful. For example, the organic solvent should be immiscible with water and does not form an azeotrope with 1,2-dichloroethane or ethyl acetate. Preferably, the organic solvent comprises cyclopentane or cycloheptane. In a specific aspect, the organic solvent is cyclopentane.

The reaction solvent mixture can be (e.g., slowly) added to the anti-solvent mixture, wherein the anti-solvent mixture can be used in an amount sufficient to induce precipitation. For example, 100 grams (g) reaction mixture can be added to 300 to 700 g, preferably 390 to 595 g, of the anti-solvent mixture. In an aspect, the antisolvent can have an organic solvent to water weight ratio of 1:1 to 1:1, or 1:2 to 1:5, or 1:3 to 1:4.5.

The precipitated sulfonated poly(phenylene ether) can be filtered, and optionally washed and dried. The filtrate can be diphasic with the 1,2-dichloroethane, cosolvent, and optionally organic(s) (e.g., cyclohexane or cycloheptane) that were part of the anti-solvent mixture, as the organic phase and water as the aqueous phase. Hence, the filtrate can be further processed to recover at least one of the 1,2-dichloroethane, the cosolvent, or water; preferably to recover 1,2-dichloroethane and the cosolvent, more preferably to recover 1,2-dichloroethane, the cosolvent, and the water. Recovering the materials can comprise decanting the diphasic filtrate to form an aqueous stream and an organic stream. The organic stream can be further processed, e.g., distilled, to recover the 1,2-dichloroethane or the cosolvent. The recovered materials can be recycled. Selection of the antisolvent so as not form an azeotrope with 1,2-dichloroethane or ethyl acetate as described herein can advantageously result in increased recovery of solvent or cosolvent for recycling and reuse in subsequent processes.

The method described herein can provide sulfonated poly(phenylene ether) having a high degree of sulfonation and a high degree of monosulfonated repeating units. According, a sulfonated poly(phenylene ether) represents another aspect of the present disclosure.

Sulfonated poly(phenylene ether) as used herein refers to a polymer comprising repeating units according to the formula

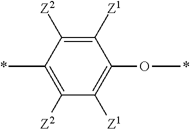

wherein in the foregoing formula, Z¹ is independently at each occurrence a sulfonic acid group, a sulfonyl chloride group, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and Z² is independently at each occurrence a sulfonic acid group, a sulfonyl chloride group, hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. In an aspect, at least one occurrence of Z² is a sulfonic acid group or a sulfonyl chloride group. In an aspect, each occurrence of Z¹ is a C₁₋₆ alkyl group, preferably a methyl group. In an aspect, the sulfonated poly(phenylene ether) can be derived from poly(2,6-dimethyl-1,4-phenylene ether).

The sulfonated poly(phenylene ether) has a degree of sulfonation of 15 to 50%. Degree of sulfonation can be determined, for example, using nuclear magnetic resonance (NMR) spectroscopy. In an aspect, the sulfonated poly(phenylene ether) can have a degree of sulfonation of 15 to 40%, or 15 to 30%. The sulfonated poly(phenylene ether) can therefore further comprise nonsulfonated repeating units.

In an advantageous feature, the sulfonated poly(phenylene ether) according to the present disclosure can have a high degree of monosubstitution. Stated another way, a majority of sulfonated repeating units of the sulfonated poly(phenylene ether) can have a single sulfonate/sulfonic acid group (i.e., a monosubstituted repeating unit). For example, at least 90% of the sulfonated poly(phenylene ether) repeating units are monosubstituted. It is noted that the term “monosubstituted” as used herein is not equivalent to “uniformly substituted”. The term “uniform substitution” refers to a sulfonated poly(phenylene ether) product having a certain degree of sulfonation that is uniform throughout the mass of the product. In contrast, “monosubstituted” as used herein means that a sulfonated poly(phenylene ether) product has a certain (uniform) degree of sulfonation across the mass of the product, and further that at least 90% of the repeat units bearing a sulfonate group have only one sulfonate group. For example, a sulfonated poly(phenylene ether) product having a uniform degree of substitution of 20% means that the degree of substitution is 20% across the entire mass of the product. In the present application, a monosulfonated poly(phenylene ether) product having a degree of substitution of 20% means that, for example, out of the 20 repeat units which are sulfonated (assuming 100 repeat units total in the polymer for each of calculation), at least 90% of those 20 repeat units have only one sulfonate group (i.e., at least 18 of the 20 repeat units have one sulfonate group).

The sulfonated poly(phenylene ether) can further have a total residual solvent content of less than 0.2 weight percent, based on the total weight of the sulfonated poly(phenylene ether). Residual solvent content can be determined using gas chromatography. In an aspect, the sulfonated poly(phenylene ether) can have a total residual ethyl acetate content of less than 0.05 weight percent, based on the total weight of the sulfonated poly(phenylene ether), as determined using gas chromatography.

This disclosure is further illustrated by the following examples, which are non-limiting.

### EXAMPLES

Sulfonated poly(phenylene) ethers were prepared and isolated according to the following procedures.

### Example 1

Poly(phenylene oxide) (PPO, 42 g) was dissolved in 1,2 dichloroethane (EDC, 378 g) and ethyl acetate (EA, 42 g) at 45° C. for 30 min under stirring using a 500 ml glass reactor (9 centimeter (cm) inner diameter) with a 45° pitched blade turbine impeller (6 cm diameter)). Once the solution was homogeneous and clear, chloro-sulfonic acid (CSA, 17.22 g) was added slowly over a period of 30-40 min maintaining a temperature of 45° C. The reaction was conducted for 3.5 hours after addition of CSA with continuous agitation (300 rpm, tip speed=0.94 m/s). A fraction of reaction mass (100 g) was quenched in chilled de-mineralized (DM) water (400 g) and n-hexane (100 g) mixture maintained at 10-12° C. The quenched reaction mass was then filtered out using Buchner funnel to separate solvents and sulfonated PPE (sPPE). The wet cake of sPPE (40 g) containing 80-85% water and hexane was then dried under vacuum (12 mmHg) at room temperature (e.g., 25-30° C.) for 48 hours to obtain a residual water content of less than 5 weight percent.

### Example 2

PPO (75 g) was dissolved in 1,2 dichloroethane (300 g) and ethyl acetate (33.38 g) at 45° C. for 30 min under stirring using a 500 ml glass reactor (9 cm inner diameter) with a 45° pitched blade turbine impeller (6 cm diameter). Once the solution was homogeneous and clear, chloro-sulfonic acid (28.84 g) was added slowly over a period of 30-40 min maintaining temperature of reactor to 45° C. The reaction was conducted for 3.5 hours after addition of CSA with continuous agitation (300 rpm, tip speed=0.94 m/s). A fraction of reaction mass (100 g) was quenched in chilled de-mineralized (DM) water (400 g) and n-hexane (100 g) mixture maintained at 10-12° C. The quenched reaction mass was then filtered out using Buchner funnel to separate solvents and sulfonated PPE (sPPE). The wet cake of sPPE (96 g) containing 80-85% water and hexane was then dried under vacuum (12 mmHg) at room temperature (25-30° C.) for 48 hours to obtain a residual water content of less than 5 weight percent.

### Comparative Example 3

PPO (42 g) was dissolved in 1,2 dichloroethane (394.38 g) and ethyl acetate (25.62 g) at 45° C. for 30 min under stirring using a 500 ml glass reactor (9 cm inner diameter) with a 45° pitched blade turbine impeller (6 cm diameter). Once the solution was homogeneous and clear, chloro-sulfonic acid (23.94 g) was added slowly over a period of 30-40 min maintaining temperature of reactor to 45° C. The reaction was conducted for 3.5 hours after addition of CSA with continuous agitation (300 rpm, tip speed=0.94 m/s). A fraction of reaction mass (100 g) was quenched in chilled de-mineralized (DM) water (400 g) and n-hexane (100 g) mixture maintained at 10-12° C. The quenched reaction mass was then filtered out using Buchner funnel to separate solvents and sulfonated PPE (sPPE). The wet cake of sPPE (40 g) containing 80-85% water and hexane was then dried under vacuum (12 mmHg) at room temperature (25-30° C.) for 48 hours to obtain a residual water content of less than 5 weight percent.

The results of Examples 1-3 are provided in Table 1. As shown in Table 1, a degree of sulfonation in the range of 20 to 30%, or 25 to 30%, could be achieved using a homogenous reaction mixture with the poly(phenylene ether) present in the reaction mixture in amounts up to 20 weight percent and with a CSA/PPE ratio of less than 0.5.

TABLE 1

| | | | | Comparative |
|---|---|---|---|---|
| | Unit | Example 1 | Example 2 | Example 3 |
| Batch Size | g of | 42 | 75 | 42 |
| | PPE | | | |
| EDC/PPE | wt/wt | 9 | 4 | 9.39 |
| EA/PPE | wt/wt | 1 | 0.44 | 0.61 |
| CSA/PPE | wt/wt | 0.41 | 0.385 | 0.57 |
| Total DS | % | 28.9 | 28.9 | 23.5 |
| Mn | g/mol | 89174 | 87834 | 79514 |
| Mw | g/mol | 167155 | 167175 | 152251 |
| PDI | | 1.9 | 1.9 | 1.9 |
| Oligomer | wt % | 0.28 | 0.27 | 0.48 |
| (<500 amu) | | | | |
| Oligomer | wt % | 0.33 | 0.33 | 0.58 |
| (<1000 amu) | | | | |
| (—SO₃H) | in | 28.10 | 28.31 | 22.58 |
| | DS % | | | |
| (—SO₂Cl) | in | 0.7956 | 0.5905 | 0.9189 |
| | DS % | | | |
| IEC | meq/g | 1.95 | 2.02 | 1.63 |
| Metals | ppm | 67.25 | 105.31 | 55.89 |
| Turbidity | NTU | 0.5 | 0.5 | 2.8 |

In current processes, hexane is typically used as an antisolvent to precipitate the sulfonated product. Hexane forms an azeotrope with ethyl acetate, dichloroethane, and water, which makes solvent recovery difficult. For example, an entrainer would be needed in distillation in order to recover pure solvents when hexane is used as an antisolvent. Alternative cosolvents were therefore investigated in order to provide an improved isolated procedure. Criteria for selecting a suitable antisolvent include: (1) organic solvent that is immiscible with water; (2) does not dissolve sulfonated poly(phenylene ether); (3) capable of extracting ethyl acetate and dichloroethane; (4) does not form an azeotrope with either of ethyl acetate or dichloroethane; and (5) may form an azeotrope with water.

The following solvents were investigated for use in isolating sulfonated poly(phenylene ether): hexane, cyclopentane, heptane, cycloheptane, n-octane, and i-octane. Table 2 summarizes the azeotropic behavior of each of these solvents with the solvents used in the reaction.

TABLE 2

| | Hexane | Cyclopentane | Heptane | Cycloheptane | n-Octane | i-Octane |
|---|---|---|---|---|---|---|
| Ethylene Dichloride | Yes | No | Yes | No | No | Yes |
| (EDC) | | | | | | |
| Ethyl Acetate (EA) | Yes | No | Yes | No | Yes | Yes |
| Water | Yes | Yes | Yes | Yes | Yes | Yes |

Extraction of EDC and EA in the various organic solvents above was simulated at 25° C. using decanter model in ASPEN PLUS. The quantities for the extraction simulation are provided in Table 3. In the simulation, organic and aqueous layers were separated using decanter model. The theoretical composition of the respective supernatant organic layers is given in Table 3. The composition of the respective supernatant organic layers determined from the simulation is given in Table 4. Based on the simulated and theoretical weight percent of each solvent in the organic layer, percent recoveries of the respective solvents were estimated, as compiled in Table 5.

TABLE 3

| Chemicals | Quantity (kg) |
|---|---|
| EDC | 900 |
| EA | 100 |
| Co-antisolvent | 1150 |
| DI Water | 4500 |
| Organic Layer | 2150 |
| Quantity | Theoretical wt % in organic layer |
| EDC | 41.86 |
| EA | 4.65 |
| Co-antisolvent | 53.49 |

TABLE 4

| | Theoretical | n-hexane | Cyclopentane | n-Heptane | Cycloheptane | n-Octane | Isooctane |
|---|---|---|---|---|---|---|---|
| EA | 4.65 | 3.91 | 4.15 | 3.86 | 4.09 | 3.83 | 4.04 |
| EDC | 41.86 | 41.65 | 41.76 | 41.62 | 41.61 | 41.64 | 41.59 |
| Anti Solvent | 53.49 | 53.99 | 53.77 | 54.03 | 53.66 | 54.03 | 53.69 |

TABLE 5

| | Theoretical | n-hexane | Cyclopentane | n-Heptane | Cycloheptane | n-Octane | Isooctane |
|---|---|---|---|---|---|---|---|
| EA | 100% | 83.30% | 88.80% | 82.20% | 87.60% | 81.40% | 86.50% |
| EDC | 100% | 98.60% | 99.20% | 98.40% | 99.10% | 98.50% | 99.00% |
| Anti Solvent | 100% | 100.00% | 100.00% | 100.00% | 100.00% | 100.00% | 100.00% |

Based on the quantities shown in Table 6, the theoretical composition of the supernatant organic layer was calculated. The actual composition of the organic layer was determined from 1H NMR analysis, as shown in Table 7. Based on the actual and theoretical weight percent of each solvent in organic layer, percent recoveries of respective solvents were determined, shown in Table 8.

TABLE 6

| Chemicals | Quantity (g) |
|---|---|
| Reaction mass | 10 |
| EDC | 7.78 |
| EA | 0.86 |
| Co-antisolvent | 10 |
| DI Water | 40 |
| Organic Layer | 18.64 |
| | Theoretical Quantity (wt %) |
| EDC | 41.74 |
| EA | 4.61 |
| Co-antisolvent | 53.65 |

TABLE 7

| | Recovered | |
|---|---|---|
| Extraction cosolvent | solvent | Wt % |
| Hexane | EA | 2.65 |
| | EDC | 41.08 |
| | Hexane | 56.26 |
| Heptane | EA | 2.71 |
| | EDC | 42.38 |
| | Heptane | 54.91 |
| Cyclopentane | EA | 2.95 |
| | EDC | 43.46 |
| | CP | 53.58 |
| n-octane | EA | 2.24 |
| | EDC | 35.07 |
| | n-octane | 62.70 |
| i-octane | EA | 2.26 |
| | EDC | 39.18 |
| | i-oct | 58.56 |

TABLE 8

| | Theoretical | n-hexane | Cyclopentane | n-Heptane | Cycloheptane | n-Octane | Isooctane |
|---|---|---|---|---|---|---|---|
| EA | 100% | 57.17% | 64.02% | 58.83% | 45.52% | 48.45% | 48.95% |
| EDC | 100% | 98.80% | 104.13% | 101.53% | 99.43% | 84.02% | 93.87% |
| Anti-solvent | 100% | 104.62% | 99.88% | 102.35% | 105.13% | 116.87% | 109.16% |

### Determination of the Substitution Pattern of Sulfonated PPE

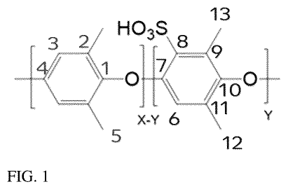

1H NMR of the sPPE samples prepared as described above, used for the measurement of the degree of substitution (DS), is insufficient to determine the substitution pattern (mono vs. disubstituted). This is due to a lower signal dispersion of the ¹H NMR spectra. The present inventors have resolved this problem by analyzing the ¹³C spectra, having much higher signal dispersion. Since the ¹H resonances were well resolved, a 2D ¹H-¹³C gradient assisted heteronuclear single quantum coherence (gHSQC) experiment was run to connect the proton signals with the corresponding carbon resonances. The carbon peak of C₁₃, from the substituted sPPE ring (shown in FIG. 1) yields a well resolved peak in ¹³C NMR at around 14.6 ppm. The signal intensity of this peak is compared with that of the aromatic resonance of C₆ in the substituted ring.

The ratio is the apparent degree of mono-substitution, shown in Table 9. The DS (%) is also given in the Table 9. It is evident that for the entire range of degree of sulfonation (20-35%) in the 11 samples analyzed, the mono-substitution is 90% or greater.

TABLE 9

| | | | | Mono-substitution |
|---|---|---|---|---|
| Example | DS % | Integral C₆ | Integral C₁₃ | ratio (C₆/C₁₃) |
| E4 | 20.1 | 93 | 100 | 0.93 |
| E5 | 20.8 | 94.9 | 100 | 0.95 |
| E6 | 24.7 | 96.1 | 100 | 0.96 |
| E7 | 24.8 | 92.7 | 100 | 0.93 |
| E8 | 26 | 95.4 | 100 | 0.95 |
| E9 | 26.7 | 98.7 | 100 | 0.99 |
| E10 | 28.9 | 99.9 | 100 | 1.0 |
| E11 | 29.0 | 95.5 | 100 | 0.96 |
| E12 | 29.1 | 99.1 | 100 | 0.99 |
| E13 | 29.4 | 89.8 | 100 | 0.90 |
| E14 | 35 | 99.1 | 100 | 0.99 |

After identification of the above-described conditions and solvents for obtaining sulfonated poly(phenylene ether), the following examples were conducted to further determine the composition of the final sulfonated poly(phenylene ether) products.

### Example 15

Polyphenylene oxide (PPO, 75 g) was dissolved in 1,2 dichloroethane (EDC, 300 g) and ethyl acetate (EA, 33 g) at 60° C. for 60 min under stirring using a 500 ml glass reactor (9 cm inner diameter) with a 45° pitched blade turbine impeller (6 cm diameter) in a laboratory setup. Once the solution was homogeneous and clear, chloro-sulfonic acid (CSA, 28.875 g) was added slowly over a period of 30-40 min maintaining temperature of reactor to 60° C. to achieve target degree of sulfonation (DS, %) of 28-30%. The reaction was conducted for 2 hours after addition of CSA with continuous agitation (300 rpm, tip speed=0.94 m/s).

Following completion of the reaction, 90 g of reaction mass from above reaction, was quickly added to a 1 liter baffled precipitation reactor with pitched blade turbine containing 360 g of water and 90 g of n-hexane, maintained at 8-10° C. and 420 rpm. The slurry formed was maintained under agitation for 1 h followed by filtration of the solid. Wet cake produced was further washed using the same reactor having 216 g of water and 54 g of n-hexane under an agitation of 300 rpm, 1 h remove the residuals at 25° C. This washing process was carried out five times to obtain a desired residual solvent content in the final product. The wet cake after washings was dried in a vacuum oven at 25° C. and 10-20 mbar vacuum for 70-90 h to get the final sulfonated PPE powder with moisture <5 wt %.

### Example 16

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution was homogeneous and clear, 38.5 g CSA was added slowly over a period of 30-40 min maintaining temperature of reactor to 60° C. to achieve target DS of 28-30%. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane (CP), maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 17

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution was homogeneous and clear, 38.04 g CSA was added slowly over a period of 30-40 min maintaining temperature of reactor to 60° C. to achieve target DS of 28-30%. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane, maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 18

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution was homogeneous and clear, 35.35 g chloro-sulfonic acid (CSA) was added slowly over a period of 30-40 min maintaining temperature of reactor to 60° C. to achieve target DS % of 24-26. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane, maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 19

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution was homogeneous and clear, 35.0 g CSA was added slowly over a period of 30-40 min maintaining temperature of reactor to 60° C. to achieve target DS % of 24-26. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane, maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 20

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution was homogeneous and clear, 26.35 g CSA was added slowly over a period of 30-40 min maintaining temperature of reactor to 60° C. to achieve target DS of 20-22%. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane, maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 21

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution was homogeneous and clear, 27.67 g CSA was added slowly over a period of 30-40 min maintaining temperature of reactor to 60° C. to achieve target DS % of 20-22. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane, maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 22

PPO (100 g) was dissolved in 1,2 dichloroethane (400 g) and ethyl acetate (33 g) at 60° C. for 60 min under stirring using a 1 liter glass reactor (9 cm inner diameter) with a 45° pitched blade turbine impeller (6 cm diameter) in a laboratory setup. Once the solution is homogeneous and clear, 27.67 g CSA was added slowly over a period of 30-40 min maintaining temperature of reactor to 60° C. to achieve target DS of 20-22%. The reaction was conducted for 2 h after addition of CSA with continuous agitation (300 rpm, tip speed=0.94 m/s).

Following completion of the reaction, 520 g of reaction mass from above reaction, was quickly added to a 5 liter non-baffled precipitation reactor with pitched blade turbine containing 2080 g of water and 520 g of cyclopentane, maintained at 8-10° C. and 750 rpm. The slurry formed was maintained under agitation for 2 h followed by filtration of the solid. Wet cake produced was further washed using the same reactor having 1248 g of water and 312 g of cyclopentane under an agitation of 170 rpm, 2 h remove the residuals at 25° C. This washing process was carried out five times to get the desired residual solvent content in the final wet cake. This cake was further dried in a vacuum oven at 25° C. and 10-20 mbar vacuum for 70-90 h to get the final sulfonated PPE powder with moisture <5 wt %.

### Example 23

PPO (75 g) was dissolved in 1,2 dichloroethane (300 g) and ethyl acetate (33 g) at 60° C. for 60 min under stirring using a 500 ml glass reactor (9 cm inner diameter) with a 45° pitched blade turbine impeller (6 cm diameter) in a laboratory setup. Once the solution was homogeneous and clear, 21.6 g CSA was added slowly over a period of 30-40 min maintaining temperature of reactor to 60° C. to achieve target DS of 20-22%. The reaction was conducted for 2 h after addition of CSA with continuous agitation (300 rpm, tip speed=0.94 m/s).

Following completion of the reaction, 90 g of reaction mass from above reaction, was quickly added to a 1 liter baffled precipitation reactor with pitched blade turbine containing 360 g of water and 90 g of cyclopentane, maintained at 8-10° C. and 420 rpm. The slurry formed was maintained under agitation for 1 h followed by filtration of the solid. Wet cake produced was analyzed for residual solvents without drying it.

### Example 24

PPO (75 g) dissolved in 1,2 dichloroethane (300 g) and ethyl acetate (33 g) at 60° C. for 60 min under stirring using a 500 ml glass reactor (9 cm inner diameter) with a 45° pitched blade turbine impeller (6 cm diameter) in a laboratory setup. Once the solution was homogeneous and clear, 21.6 g CSA was added slowly over a period of 30-40 min maintaining temperature of reactor to 60° C. to achieve target DS % of 20-22. The reaction was conducted for 2 h after addition of CSA with continuous agitation (300 rpm, tip speed=0.94 m/s).

Following completion of the reaction, 90 g of reaction mass from above reaction, was quickly added to a 1 liter baffled precipitation reactor with pitched blade turbine containing 360 g of water and 90 g of cyclopentane, maintained at 8-10° C. and 420 rpm. The slurry formed was maintained under agitation for 1 h followed by filtration of the solid. Wet cake produced was dried in a vacuum oven at 25° C. and 10-20 mbar vacuum for 70-90 h to get the final sulfonated PPE powder with moisture <5 wt %.

Samples were analyzed using an Agilent headspace gas chromatography (GC) instrument equipped with CP-waX-52cb column dimensions of 50 m×320 μm×1.2 μm, using ultra-pure helium as carrier gas with a column flow rate of 2 milliliters per minute (ml/min), a split ratio of 20:1 and an injector temperature of 240° C. A flame ionization detector was used. The headspace oven was maintained at 80° C. and equilibrated with headspace vial for 30 minutes before the injection.

To quantitatively analyze residual solvent content, calibrations using external solvents in known concentrations were done. The vapors generated in each calibration samples was injected to the column to record its response using the flame ionization detector, and a calibration curve was generated using the known concentration and the area under the curve for the designated chromatogram peak. The detection limit for this analysis was 5 ppm.

Samples of sulfonated poly(phenylene ether) (sPPE) according to the foregoing examples were prepared by dissolving 0.5 grams of sPPE in 5 milliliters of NMP and analyzing the sample using gas chromatography. The calibration curves were used to determine the concentration of residual solvent in each sample.

The experimental conditions and resulting residual solvent content for each example is summarized in Table 10.

TABLE 10

| Condition | Units | Ex. 15 | Ex. 16 | Ex. 17 | Ex. 18 | Ex. 19 | Ex. 20 | Ex. 21 | Ex. 22 | Ex. 23 | Ex. 24 |
|---|---|---|---|---|---|---|---|---|---|---|---|
| PPO solid | wt % | 17.2 | 17.5 | 17.6 | 17.6 | 17.6 | 17.9 | 17.89 | 17.89 | 17.5 | 17.5 |
| content | | | | | | | | | | | |
| CSA/PPO | | 0.385 | 0.385 | 0.380 | 0.354 | 0.350 | 0.264 | 0.277 | 0.277 | 0.288 | 0.288 |
| DS | % | 27.4 | 28.40 | NA | 24.60 | 24.10 | 19.30 | 19.30 | 20.10 | 22.00 | 22.00 |
| Antisol/ | w/w | 5 | 5 | 5 | 5 | 5 | 5 | 5 | 5 | 5 | 5 |
| Rxnmass | | | | | | | | | | | |
| ratio | | | | | | | | | | | |
| Antisol. | | Hexane + | Cyclo- | Cyclo- | Cyclo- | Cyclo- | Cyclo- | Cyclo- | Cyclo- | Cyclo- | Cyclo- |
| | | water | pentane + | pentane + | pentane + | pentane + | pentane + | pentane + | pentane + | pentane + | pentane + |
| | | | water | water | water | water | water | water | water | water | water |
| Agitation | rpm | 420 | 750 | 750 | 750 | 750 | 750 | 750 | 750 | 420 | 420 |
| precip. | | | | | | | | | | | |
| Time of | h | 1 | 2 | 2 | 2 | 2 | 2 | 2 | 2 | 1 | 1 |
| agitation | | | | | | | | | | | |
| Antisol/ | w/w | 3 | 3 | 3 | 3 | 3 | 3 | 3 | 3 | 3 | 3 |
| Rxnmass | | | | | | | | | | | |
| ratio, | | | | | | | | | | | |
| washing | | | | | | | | | | | |
| Agitation | rpm | 300 | 170 | 170 | 170 | 170 | 170 | 170 | 170 | 0 | 0 |
| washing | | | | | | | | | | | |
| Time of | h | 1 | 1 | 1 | 1 | 1 | 1 | 1 | 1 | 0 | 0 |
| agitation | | | | | | | | | | | |
| No. of | | 5 | 5 | 5 | 5 | 5 | 5 | 5 | 5 | 0 | 0 |
| washes | | | | | | | | | | | |
| Drying | ° C./ | 25/ | 25/ | 25/ | 25/ | 25/ | 25/ | 25/ | 25/ | — | 25/ |
| T/P | mbar | 10-20 | 10-20 | 10-20 | 10-20 | 10-20 | 10-20 | 10-20 | 10-20 | | 10-20 |
| Residual | | | | | | | | | | | |
| Solvent | | | | | | | | | | | |
| EDC | ppm | n.d. | n.d. | n.d. | n.d. | n.d. | n.d. | n.d. | n.d. | n.d. | n.d. |
| EA | ppm | 79.72 | 0.66 | 0.85 | 0.7 | 0.28 | 2.95 | 4.6 | 9.66 | 271.52 | 0.48 |
| CP | ppm | n.d | 212.49 | 258.55 | 580.52 | 219.75 | 129.83 | 474.70 | 1149.39 | 1458.34 | 1179.46 |
| Hexane | ppm | n.d. | n.d. | n.d. | n.d. | n.d. | n.d. | n.d. | n.d. | n.d. | n.d. |
| Total | ppm | 79.72 | 213.15 | 259.40 | 581.22 | 220.03 | 132.78 | 479.30 | 1159.05 | 1729.86 | 1179.94 |
| Solvent | | | | | | | | | | | |
| Total | wt % | 0.008 | 0.021 | 0.026 | 0.058 | 0.022 | 0.013 | 0.048 | 0.116 | 0.173 | 0.118 |
| Solvent | | | | | | | | | | | |

*Indicates a comparative example

As shown in Table 1, it can be seen that EDC was not detected in any example. EA and CP were both observed to be present in amounts within an acceptable range.

This disclosure further encompasses the following aspects.

Aspect 1: A sulfonated poly(phenylene ether) comprising: repeating units of the formula

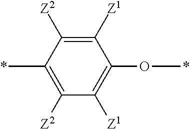

wherein in the foregoing formula, Z¹ is independently at each occurrence a sulfonic acid group, a sulfonyl chloride group, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; Z² is independently at each occurrence a sulfonic acid group, a sulfonyl chloride group, hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and wherein the sulfonated poly(phenylene ether) has a degree of sulfonation of 15 to 50% as determined by nuclear magnetic resonance spectroscopy; and wherein at least 90% of the sulfonated poly(phenylene ether) repeating units of the sulfonated poly(phenylene ether) are monosubstituted.

Aspect 2: The sulfonated poly(phenylene ether) of aspect 1, wherein the sulfonated poly(phenylene ether) has a total residual solvent content of less than 0.2 weight percent, based on the total weight of the sulfonated poly(phenylene ether), as determined using gas chromatography.

Aspect 3: The sulfonated poly(phenylene ether) of aspect 1 or 2, wherein the sulfonated poly(phenylene ether) is made by a method comprising: contacting a poly(phenylene ether) with a sulfonating agent in the presence of a solvent comprising 1,2-dichloroethane and a cosolvent comprising ethyl acetate to provide a mixture comprising the sulfonated poly(phenylene ether); wherein the poly(phenylene ether) is present in an amount of greater than or equal to 8 weight percent, based on the total weight of the poly(phenylene ether), the sulfonating agent, the solvent, and the cosolvent, preferably wherein the poly(phenylene ether) is present in an amount of 8 to 25 weight percent; the cosolvent is present in an amount of 7 to 15 weight percent based on the total weight of the solvent and the cosolvent; and wherein the sulfonating agent is present in a weight ratio of sulfonating agent to poly(phenylene ether) of less than 0.5:1, preferably 0.1:1 to 0.45:1.

Aspect 4: The sulfonated poly(phenylene ether) of aspect 3, wherein the sulfonated poly(phenylene ether) is made by a method further comprising adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether); and isolating the sulfonated poly(phenylene ether).

Aspect 5: The sulfonated poly(phenylene ether) of any of aspects 1 to 4, wherein at least one of Z² is a sulfonic acid group or a sulfonyl chloride group.

Aspect 6: The sulfonated poly(phenylene ether) of any of aspects 1 to 5, wherein each of Z¹ is a methyl group.

Aspect 7: The sulfonated poly(phenylene ether) of any of aspects 1 to 6, wherein the sulfonated poly(phenylene ether) has a total residual ethyl acetate content of less than 0.05 weight percent, based on the total weight of the sulfonated poly(phenylene ether), as determined using gas chromatography.

Aspect 8: The sulfonated poly(phenylene ether) of aspect 1, wherein the sulfonated poly(phenylene ether) comprises repeating units of the formula

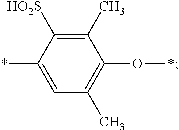

wherein the sulfonated poly(phenylene ether) has a degree of sulfonation of 15 to 40 percent, as determined by nuclear magnetic resonance spectroscopy; wherein at least 90% of the sulfonated poly(phenylene ether) repeating units of the sulfonated poly(phenylene ether) are monosubstituted; wherein the sulfonated poly(phenylene ether) has a total residual solvent content of less than 0.2 weight percent, based on the total weight of the sulfonated poly(phenylene ether), as determined using gas chromatography; and wherein the sulfonated poly(phenylene ether) is made by a method comprising: contacting a poly(phenylene ether) with a sulfonating agent in the presence of a solvent comprising 1,2-dichloroethane and a cosolvent ethyl acetate to provide a mixture comprising the sulfonated poly(phenylene ether), wherein the poly(phenylene ether) is present in an amount of 8 to 25 weight percent, based on the total weight of the poly(phenylene ether), the sulfonating agent, the solvent, and the cosolvent; the cosolvent is present in an amount of 7 to 15 weight percent based on the total weight of the solvent and the cosolvent; and the sulfonating agent is present in a weight ratio of sulfonating agent to poly(phenylene ether) of 0.1:1 to 0.45:1; adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether); and isolating the precipitated sulfonated poly(phenylene ether).

Aspect 9: A membrane comprising the sulfonated poly(phenylene ether) of any of aspects 1 to 8.

Aspect 10: A method of making a sulfonated poly(phenylene ether), the method comprising: contacting a poly(phenylene ether) with a sulfonating agent in the presence of a solvent comprising 1,2-dichloroethane and a cosolvent comprising ethyl acetate under conditions effective to provide a mixture comprising the sulfonated poly(phenylene ether); and isolating the sulfonated poly(phenylene ether) from the mixture; wherein the poly(phenylene ether) is present in an amount of greater than or equal to 8 weight percent, based on the total weight of the poly(phenylene ether), the sulfonating agent, the solvent, and the cosolvent, preferably wherein the poly(phenylene ether) is present in an amount of 8 to 25 weight percent; the cosolvent is present in an amount of 7 to 15 weight percent based on the total weight of the solvent and the cosolvent; and wherein the sulfonating agent is present in a weight ratio of sulfonating agent to poly(phenylene ether) of less than 0.5:1, preferably 0.1:1 to 0.45:1.

Aspect 11: The method of aspect 10 or 11, further comprising adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether); isolating the sulfonated poly(phenylene ether); and optionally, washing the isolated sulfonated poly(phenylene ether) with the antisolvent.

Aspect 12: The method of aspect 11, wherein the organic solvent comprises cyclopentane or cycloheptane, preferably cyclopentane.

Aspect 13: The method of any of aspects 10 to 12, wherein the isolated sulfonated poly(phenylene ether) has a degree of sulfonation of 15 to 50 percent, as determined by nuclear magnetic resonance spectroscopy; wherein at least 90% of the sulfonated repeat units of the sulfonated poly(phenylene ether) are monosubstituted; and optionally, wherein the isolated sulfonated poly(phenylene ether) has a combined residual solvent content of less than 0.2 weight percent, based on the total weight of the sulfonated poly(phenylene ether), as determined using gas chromatography.

Aspect 14: The method of aspect 10, comprising: contacting the poly(phenylene ether) with the sulfonating agent in the presence of the solvent comprising 1,2-dichloroethane and the cosolvent comprising ethyl acetate under conditions effective to provide a mixture comprising the sulfonated poly(phenylene ether), wherein the poly(phenylene ether) is present in an amount of 8 to 25 weight percent, based on the total weight of the poly(phenylene ether), the sulfonating agent, the solvent, and the cosolvent; the cosolvent is present in an amount of 7 to 15 weight percent based on the total weight of the solvent and the cosolvent; and the sulfonating agent is present in a weight ratio of sulfonating agent to poly(phenylene ether) of 0.1:1 to 0.45:1; adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether); isolating the precipitated sulfonated poly(phenylene ether); and optionally, washing the isolated sulfonated poly(phenylene ether) with the antisolvent; wherein the organic solvent comprises cyclopentane or cycloheptane; and wherein the isolated sulfonated poly(phenylene ether) has a degree of sulfonation of 15 to 50 percent, as determined by nuclear magnetic resonance spectroscopy; wherein at least 90% of the sulfonated repeat units of the sulfonated poly(phenylene ether) are monosubstituted; and optionally, wherein the isolated sulfonated poly(phenylene ether) has a combined residual solvent content of less than 0.2 weight percent, based on the total weight of the sulfonated poly(phenylene ether), as determined using gas chromatography.

Aspect 15: A sulfonated poly(phenylene ether) made by the method of any of aspects 10 to 14.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A sulfonated poly(phenylene ether) comprising:
repeating units of the formula 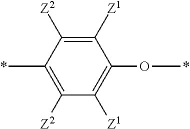
wherein in the foregoing formula,
Z¹ is independently at each occurrence a sulfonic acid group, a sulfonyl chloride group, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms;
Z² is independently at each occurrence a sulfonic acid group, a sulfonyl chloride group, hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms; and
wherein the sulfonated poly(phenylene ether) has a degree of sulfonation of 15 to 50% as determined by nuclear magnetic resonance spectroscopy; and
wherein at least 90% of the sulfonated poly(phenylene ether) repeating units of the sulfonated poly(phenylene ether) are monosubstituted.

2. The sulfonated poly(phenylene ether) of claim 1, wherein the sulfonated poly(phenylene ether) has a total residual solvent content of less than 0.2 weight percent, based on the total weight of the sulfonated poly(phenylene ether), as determined using gas chromatography.

3. The sulfonated poly(phenylene ether) of claim 1,
wherein the sulfonated poly(phenylene ether) is made by a method comprising:
contacting a poly(phenylene ether) with a sulfonating agent in the presence of a solvent comprising 1,2-dichloroethane and a cosolvent comprising ethyl acetate to provide a mixture comprising the sulfonated poly(phenylene ether);
wherein
the poly(phenylene ether) is present in an amount of greater than or equal to 8 weight percent, based on the total weight of the poly(phenylene ether), the sulfonating agent, the solvent, and the cosolvent;
the cosolvent is present in an amount of 7 to 15 weight percent based on the total weight of the solvent and the cosolvent; and
wherein the sulfonating agent is present in a weight ratio of sulfonating agent to poly(phenylene ether) of less than 0.5:1, preferably 0.1:1 to 0.45:1.

4. The sulfonated poly(phenylene ether) of claim 3, wherein the sulfonated poly(phenylene ether) is made by a method further comprising adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether); and
isolating the sulfonated poly(phenylene ether).

5. The sulfonated poly(phenylene ether) of claim 1, wherein at least one of Z² is a sulfonic acid group or a sulfonyl chloride group.

6. The sulfonated poly(phenylene ether) of claim 1, wherein each of Z¹ is a methyl group.

7. The sulfonated poly(phenylene ether) of claim 1, wherein the sulfonated poly(phenylene ether) has a total residual ethyl acetate content of less than 0.05 weight percent, based on the total weight of the sulfonated poly(phenylene ether), as determined using gas chromatography.

8. The sulfonated poly(phenylene ether) of claim 1, wherein the sulfonated poly(phenylene ether) comprises repeating units of the formula 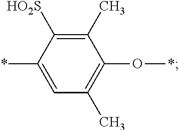
wherein the sulfonated poly(phenylene ether) has a degree of sulfonation of 15 to 40 percent, as determined by nuclear magnetic resonance spectroscopy;
wherein at least 90% of the sulfonated poly(phenylene ether) repeating units of the sulfonated poly(phenylene ether) are monosubstituted;
wherein the sulfonated poly(phenylene ether) has a total residual solvent content of less than 0.2 weight percent, based on the total weight of the sulfonated poly(phenylene ether), as determined using gas chromatography; and
wherein the sulfonated poly(phenylene ether) is made by a method comprising:
contacting a poly(phenylene ether) with a sulfonating agent in the presence of a solvent comprising 1,2-dichloroethane and a cosolvent ethyl acetate to provide a mixture comprising the sulfonated poly(phenylene ether), wherein
the poly(phenylene ether) is present in an amount of 8 to 25 weight percent, based on the total weight of the poly(phenylene ether), the sulfonating agent, the solvent, and the cosolvent;
the cosolvent is present in an amount of 7 to 15 weight percent based on the total weight of the solvent and the cosolvent; and
the sulfonating agent is present in a weight ratio of sulfonating agent to poly(phenylene ether) of 0.1:1 to 0.45:1;
adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether); and
isolating the precipitated sulfonated poly(phenylene ether).

9. A membrane comprising the sulfonated poly(phenylene ether) of claim 1.

10. A method of making a sulfonated poly(phenylene ether), the method comprising:
contacting a poly(phenylene ether) with a sulfonating agent in the presence of a solvent comprising 1,2-dichloroethane and a cosolvent comprising ethyl acetate under conditions effective to provide a mixture comprising the sulfonated poly(phenylene ether); and
isolating the sulfonated poly(phenylene ether) from the mixture;
wherein
the poly(phenylene ether) is present in an amount of greater than or equal to 8 weight percent, based on the total weight of the poly(phenylene ether), the sulfonating agent, the solvent, and the cosolvent;
the cosolvent is present in an amount of 7 to 15 weight percent based on the total weight of the solvent and the cosolvent; and
wherein the sulfonating agent is present in a weight ratio of sulfonating agent to poly(phenylene ether) of less than 0.5:1.

11. The method of claim 10, further comprising
adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether);
isolating the sulfonated poly(phenylene ether); and
optionally, washing the isolated sulfonated poly(phenylene ether) with the antisolvent.

12. The method of claim 11, wherein the organic solvent comprises cyclopentane or cycloheptane.

13. The method of claim 10, wherein the isolated sulfonated poly(phenylene ether) has a degree of sulfonation of 15 to 50 percent, as determined by nuclear magnetic resonance spectroscopy; wherein at least 90% of the sulfonated repeat units of the sulfonated poly(phenylene ether) are monosubstituted; and optionally, wherein the isolated sulfonated poly(phenylene ether) has a combined residual solvent content of less than 0.2 weight percent, based on the total weight of the sulfonated poly(phenylene ether), as determined using gas chromatography.

14. The method of claim 10, comprising:
contacting the poly(phenylene ether) with the sulfonating agent in the presence of the solvent comprising 1,2-dichloroethane and the cosolvent comprising ethyl acetate under conditions effective to provide a mixture comprising the sulfonated poly(phenylene ether), wherein
the poly(phenylene ether) is present in an amount of 8 to 25 weight percent, based on the total weight of the poly(phenylene ether), the sulfonating agent, the solvent, and the cosolvent;
the cosolvent is present in an amount of 7 to 15 weight percent based on the total weight of the solvent and the cosolvent; and
the sulfonating agent is present in a weight ratio of sulfonating agent to poly(phenylene ether) of 0.1:1 to 0.45:1;
adding the mixture comprising the sulfonated poly(phenylene ether) to an antisolvent comprising water and an organic solvent that is immiscible with water and does not form an azeotrope with 1,2-dichloroethane or ethyl acetate to form a slurry comprising a precipitated sulfonated poly(phenylene ether);
isolating the precipitated sulfonated poly(phenylene ether); and
optionally, washing the isolated sulfonated poly(phenylene ether) with the antisolvent;
wherein the organic solvent comprises cyclopentane or cycloheptane; and
wherein the isolated sulfonated poly(phenylene ether) has a degree of sulfonation of 15 to 50 percent, as determined by nuclear magnetic resonance spectroscopy; wherein at least 90% of the sulfonated repeat units of the sulfonated poly(phenylene ether) are monosubstituted; and
optionally, wherein the isolated sulfonated poly(phenylene ether) has a combined residual solvent content of less than 0.2 weight percent, based on the total weight of the sulfonated poly(phenylene ether), as determined using gas chromatography.

15. A sulfonated poly(phenylene ether) made by the method of claim 10.
